(19) United States
(12) Patent Application Publication
(10) Pub. No.: US 2017/0182519 A1
(43) Pub. Date: Jun. 29, 2017

(54) METHOD FOR MANUFACTURING REGENERATED PRODUCT

(71) Applicant: Tokyo Electric Power Company Holdings, Incorporated, Tokyo (JP)

(72) Inventors: Noboru KOBAYASHI, Tokyo (JP); Tamotsu OGAWA, Tokyo (JP); Chikara MOROOKA, Tokyo (JP); Yuki NOMOTO, Tokyo (JP); Kazuhiro ENDO, Tokyo (JP); Kenji FUKASHIRO, Tokyo (JP); Motoyoshi SUZUKI, Tokyo (JP)

(73) Assignee: Tokyo Electric Power Company Holdings, Incorporated, Tokyo (JP)

(21) Appl. No.: 15/459,428

(22) Filed: Mar. 15, 2017

Related U.S. Application Data
(63) Continuation-in-part of application No. PCT/JP2015/058531, filed on Mar. 20, 2015.

(51) Int. Cl. B08B 1/00; B24C 1/08

(52) U.S. Cl. CPC B08B 1/005; B24C 1/086

(57) ABSTRACT

A method for manufacturing a regenerated product includes a selection step for selecting a recovered regeneration object based on a first evaluation standard indicating a state of a surface of the regeneration object, a rust-removing step for performing a rust-removing treatment to the regeneration object selected by the selection step, and a judgement step for judging whether to terminate the rust-removing treatment in the rust-removing step based on a second evaluation standard indicating the state of the surface of the regeneration object.

### BACKGROUND

### Technical Fields

Embodiments of the present invention generally relate to a method for manufacturing a regenerated product.

### Related Art

In related art, a structural member made of a plating steel material can be reused as a structure for a new building by measurement of a plating film thickness of the structural member as disclosed in Japanese Unexamined Patent Application, First Publication No. 2003-239542.

However, in such a technology as described in Japanese Unexamined Patent Application, First Publication No. 2003-239542, a film thickness meter is used for measuring a thickness of a plating film, and therefore work is complicated disadvantageously. The present invention has been achieved in view of the above point, and provides a method for manufacturing a regenerated product, which can reduce labor and time for a work of manufacturing the regenerated product.

### SUMMARY

In some embodiments, a method for manufacturing a regenerated product may include, but is not limited to, selecting a recovered regeneration object based on a first evaluation standard indicating a state of a surface of the regeneration object with a discolored area; performing a rust-removing treatment to the regeneration object selected by the selection step; and judging whether to terminate the rust-removing treatment in the rust-removing step based on a second evaluation standard indicating the state of the surface of the regeneration object with the degree of discoloration.

Further features and aspects of the present disclosure will become apparent from the following detailed description of exemplary embodiments with reference to the attached drawings.

### BRIEF DESCRIPTION OF THE DRAWINGS

FIG. 1 is a schematic diagram exemplifying a work procedure in a plant for manufacturing a regenerated product in the present embodiment.

FIG. 2 is a flowchart exemplifying a rust-removing work procedure in the present embodiment.

FIG. 3 illustrates a table exemplifying a first boundary sample in the present embodiment.

FIG. 4 illustrates a table exemplifying a second boundary sample in the present embodiment.

### DETAILED DESCRIPTION OF THE EMBODIMENTS

In some embodiments, a method for manufacturing a regenerated product may include, but is not limited to, selecting a recovered regeneration object based on a first evaluation standard indicating a state of a surface of the regeneration object with a discolored area; performing a rust-removing treatment to the regeneration object selected by the selection step; and judging whether to terminate the rust-removing treatment in the rust-removing step based on a second evaluation standard indicating the state of the surface of the regeneration object with the degree of discoloration.

In some cases, the first evaluation standard is based on a boundary sample indicating a state of a surface of the recovered regeneration object according to a remaining plating thickness of the regeneration object.

In some cases, the second evaluation standard is based on a boundary sample indicating a state of a surface of the regeneration object to which the rust-removing treatment has been performed in the rust-removing step according to a remaining plating thickness of the regeneration object.

In some cases, each of the first evaluation standard and the second evaluation standard is based on a state of a color of a surface of the regeneration object.

The term “facility” used in embodiments refers to every tangible thing, which can in generally be designed, constructed, built, manufactured, installed, and maintained for performing any purpose, activities or functions in human society. In some cases, the facility may include, but is not limited to, a permanent, semi-permanent or temporary commercial or industrial property such as building, plant, or structure for performing any purpose, activities or functions in human society.

The term “event” used in embodiments refers to something that happens such as a social occasion or activity.

The term “object” used in embodiments refers to a set of one or more tangible objects, articles or physical resources such as, but not limited to, some structural or tangible elements, apparatus, devices, or implements used in an operation or activity; fixed assets other than land and buildings.

The term “equipment/material” used in embodiments refers to at least one of equipment and material, for example, equipment alone, material alone or in combination.

Hereinafter, an embodiment of a method for manufacturing a regenerated product according to the present invention will be described with reference to the drawings.

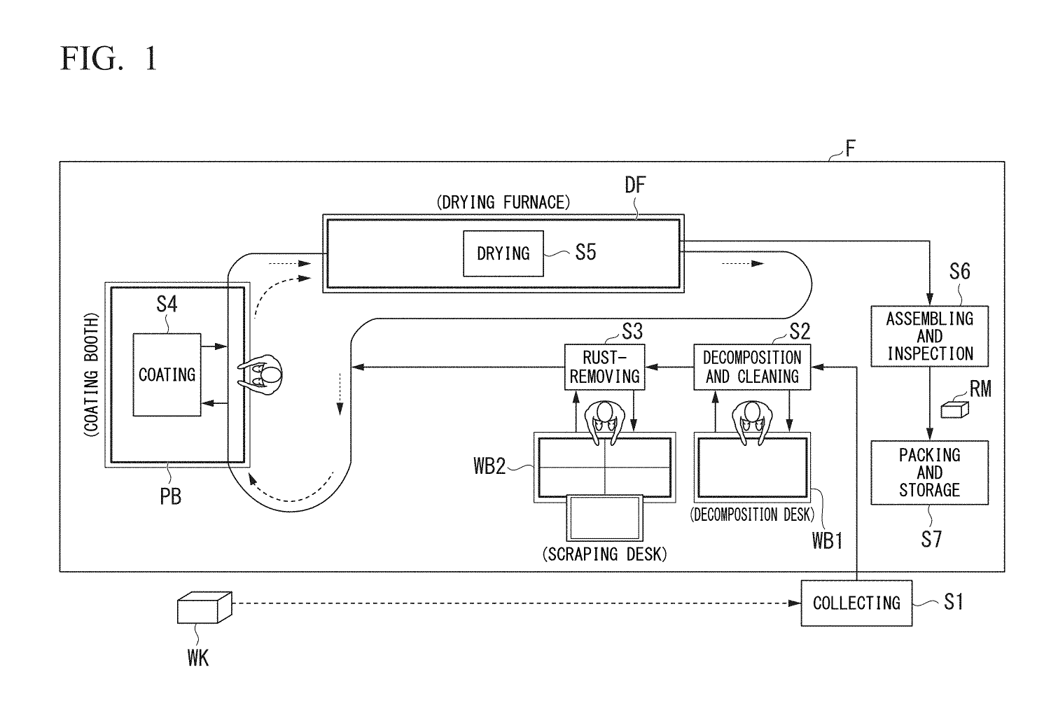

FIG. 1 is a schematic diagram exemplifying a work procedure in a plant F for manufacturing a regenerated product in the present embodiment. In this plant F for manufacturing a regenerated product, a regeneration work with respect to a recovered regeneration object WK changes the regeneration object WK to a regenerated product RM to be shipped. Examples of this regeneration object WK include metal fittings for power distribution Specific examples of the regeneration object WK include a crossarm, a band for a crossarm, an anchor metal fitting for joint use, a taking out metal fitting for joint use, a bowsprit metal fitting for joint use, a transformer hanger band, a support attachment band, and a rising cable support band. Examples of this regeneration object WK include a product containing iron as a base material, obtained by subjecting the iron material to preliminary galvanizing and hot dip galvanizing and further subjecting the galvanized layer to rust-preventing coating. That is, the regeneration object WK is obtained as a result of change after a long-term use in a product in which the base material has been subjected to a rust-preventing treatment by galvanizing and coating when the product is shipped as a new product. Rust is generated in some regeneration objects WK, and rust is not generated in some regeneration objects WK, according to the degree of this change after a long-term use. Rust progresses relatively in some regeneration objects WK having rust generated, and rust does not progress relatively in some regeneration objects WK having rust generated, according to the degree of the change after a long-term use.

An outline of the work procedure in this plant F for manufacturing a regenerated product will be described with reference to FIG. 1.

The recovered regeneration object WK is collected to the plant F for manufacturing a regenerated product (step S1). Subsequently, the regeneration object WK collected in step S1 is decomposed on a decomposition desk WB1 and cleaned (step S2).

Subsequently, rust in the regeneration object WK is removed on a scraping desk WB2 (step S3). Rust-removing in step S3 is a work for removing rust generated on a surface of the regeneration object WK by polishing the surface of the regeneration object WK. This rust-removing work includes a scraping work and a shot blasting work. In the following description, a case where the rust-removing work is a scraping work will be exemplified.

Subsequently, the regeneration object WK from which rust has been removed is coated in a coating booth PB (step S4). Specifically, in step S4, the regeneration object WK is coated with a zinc coating material containing zinc.

Subsequently, the regeneration object WK which has been coated is dried in a drying furnace DF (step S5). Subsequently, the regeneration object WK is inspected in an assembling and inspection step (step S6), and is packed as a regenerated product RM (step S7). The regenerated product RM packed is shipped from the plant F for manufacturing a regenerated product based on a shipping indication.

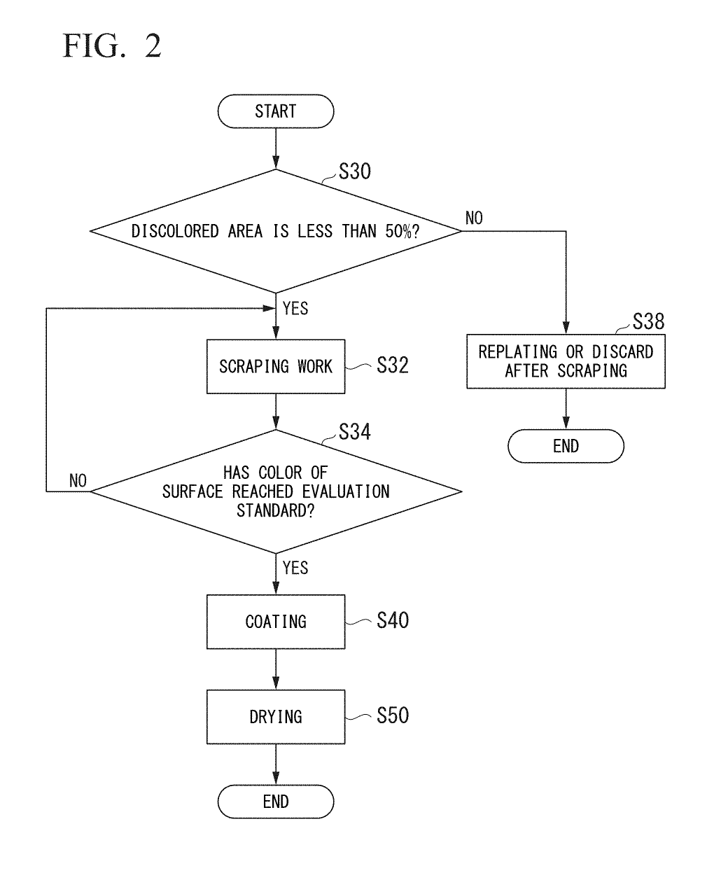

Subsequently, a detailed procedure of the above rust-removing work in step S3 will be described with reference to FIGS. 2 to 4.

FIG. 2 is a flowchart exemplifying a rust-removing work procedure in the present embodiment.

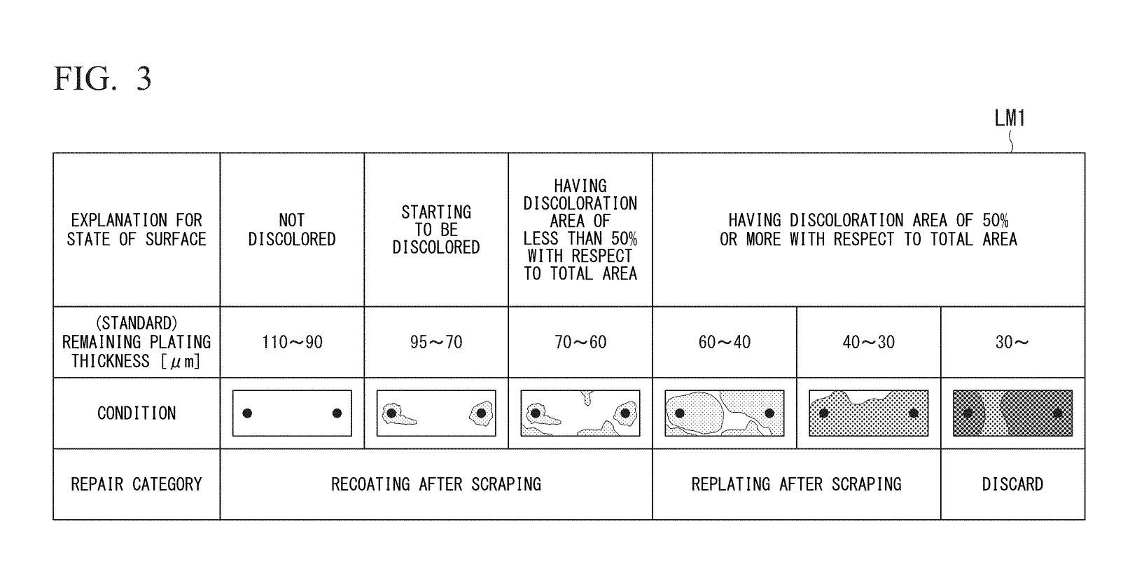

As illustrated in FIG. 2, the regeneration object WK is selected based on comparison between a state of a surface thereof and a boundary sample LM1 (step S30). Specifically, it is judged to which state the state of the surface of the regeneration object WK is close among a plurality of states indicated by the boundary sample LM1 on the scraping desk WB2. This boundary sample LM1 will be exemplified with reference to FIG. 3.

FIG. 3 illustrates a table exemplifying the boundary sample LM1 in the present embodiment. As illustrated in FIG. 3, in the boundary sample LM1, explanation for a state of a surface, a remaining plating thickness, a condition of a surface, and a repair category correspond to one another.

As the explanation for a state of a surface, an evaluation standard based on a state of a color of a surface of the regeneration object WK is described. In the column of the explanation for a state of a surface, the state of the surface of the regeneration object WK is classified into four stages. Specifically, in the column of the explanation for a state of a surface, “not discolored”, “starting to be discolored”, “having a discoloration area of less than 50% with respect to the total area”, and “having a discoloration area of 50% or more with respect to the total area” are described.

In the column of the remaining plating thickness, the remaining plating thickness of the regeneration object WK is classified into six stages. Specifically, in the column of the remaining plating thickness, “110 to 90 [μm]”, “95 to 70 [μm]38 , “70 to 60 [μm]”, “60 to 40 [μm]”, “40 to 30 [μm]”, and “30 [μm] or less” are described. Among these, “110 to 90 [μm]” in the column of the remaining plating thickness corresponds to “not discolored” in the column of the explanation for a state of a surface. “95 to 70 [μm]” in the column of the remaining plating thickness corresponds to “starting to be discolored” in the column of the explanation for a state of a surface. “70 to 60 [μm]” in the column of the remaining plating thickness corresponds to “having a discoloration area of less than 50% with respect to the total area” in the column of the explanation for a state of a surface. Each of “60 to 40 [μm]”, “40 to 30 [μm], and “30 [μm] or less” in the column of the remaining plating thickness corresponds to “having a discoloration area of 50% or more with respect to the total area” in the column of the explanation for a state of a surface. That is, in the boundary sample LM1, the state of the surface of the regeneration object WK and the remaining plating thickness correspond to each other.

In the column of a condition of a surface, a photograph of the surface of the regeneration object WK is shown as an example of a sample corresponding to each stage in the column of a remaining plating thickness.

In the column of a repair category, a repair category corresponding to each stage in the column of explanation for a state of a surface is described. Specifically, in the column of a repair category, “recoating after scraping”, “replating after scraping”, and “discard” are described. Among these, “recoating after scraping” in the column of a repair category corresponds to “not discolored”, “starting to be discolored”, and “having a discoloration area of less than 50% with respect to the total area” in the column of the explanation for a state of a surface. “Replating” and “discard” in the column of a repair category correspond to “having a discoloration area of 50% or more with respect to the total area” in the column of the explanation for a state of a surface.

As illustrated in FIG. 2, in step S30, the regeneration object WK is selected based on comparison between a state of a surface thereof and a photograph in the column of a condition of the boundary sample LM1. Specifically, when the state of the surface of the regeneration object WK corresponds to any one of “not discolored”, “starting to be discolored”, “having a discoloration area of less than 50% with respect to the total area”, the regeneration object WK is selected as an object of a scraping work. When the state of the surface of the regeneration object WK corresponds to “having a discoloration area of 50% or more with respect to the total area”, the regeneration object WK is selected as an object of a work of replating after scraping or discard. That is, the regeneration object WK is selected based on whether the state of the surface thereof corresponds to “having a discoloration area of less than 50% with respect to the total area”. When the state of the surface of the regeneration object WK corresponds to “having a discoloration area of less than 50% with respect to the total area” (step S30; YES), the regeneration object WK is selected as an object of a scraping work in step S32. When the state of the surface of the regeneration object WK corresponds to “having a discoloration area of 50% or more with respect to the total area” (step S30; NO), the regeneration object WK is selected as an object of a work of replating after scraping or discard in step S38.

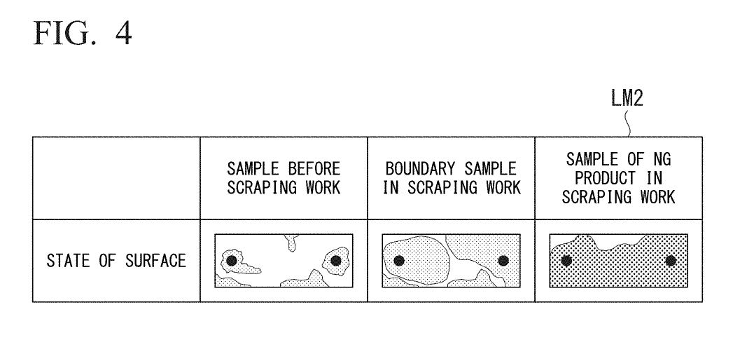

Subsequently, a scraping work is performed to the regeneration object WK in step S32. This scraping work is performed based on a boundary sample LM2 illustrated in FIG. 4.

FIG. 4 illustrates a table exemplifying the boundary sample LM2 in the present embodiment. As illustrated in FIG. 4, in the boundary sample LM2, a photograph exemplifying the state of the surface of the regeneration object WK is shown. The photograph exemplifying the state of the surface of the regeneration object WK is classified into three stages according to the degree of a scraping work. Among these, the photograph in the first stage shows a state of the surface of the regeneration object WK before the scraping work. The photograph in the second stage shows a boundary sample at the time of termination of the scraping work. The photograph in the third stage shows an NG product (product which cannot be shipped) when the scraping work is performed excessively. Here, in the boundary sample shown by the photograph in the second stage, a discolored region on the surface of the regeneration object WK remains without being removed completely. That is, in the boundary sample LM2, a state in which the discolored region of the regeneration object WK has not been removed completely is shown as a boundary sample indicating termination of the scraping work. This discolored region of the regeneration object WK indicates a region of rust generated on the surface of the regeneration object WK. That is, the state of termination of the scraping work shown by the boundary sample LM2 is a state in which rust generated on the surface of the regeneration object WK has not been removed completely.

Here, when rust has been removed completely in the scraping work, a plating alloy layer may be removed simultaneously. In this case, the remaining plating thickness of the regeneration object WK may be relatively small. Specifically, when rust has been removed completely in the scraping work, the remaining plating thickness may be less than a predetermined threshold (for example, less than 60 μm) by simultaneous removal of a plating alloy layer. When the remaining plating thickness is less than a predetermined threshold, the regeneration object WK cannot necessarily maintain a function and performance thereof in a predetermined durability period in a case where the regeneration object WK is shipped as a regenerated product RM. That is, in order to maintain the function and performance of the regenerated product RM in a predetermined durability period, the regenerated product RM needs to have a remaining plating thickness of a predetermined threshold or more at the time of shipping. The boundary sample LM2 shows a sample by which the remaining plating thickness of the regeneration object WK can be judged visually with an appearance of the regeneration object WK. More specifically, the boundary sample LM2 shows a sample by which the remaining plating thickness of the regeneration object WK can be judged with a color of the surface of the regeneration object WK.

In a general scraping work not according to the present embodiment, the regeneration object WK may be scraped until a rust color disappears. Here, when the regeneration object WK is a plated steel plate obtained by galvanizing iron (or by zinc alloy plating of iron), the regeneration object WK has a structure in which an alloy layer, a pseudo alloy layer, and a pure zinc layer are stacked on a surface of the iron in the ascending order of a distance to the iron as a base metal layer. When the regeneration object WK is scraped until a color disappears in a general scraping work not according to the present embodiment, even the alloy layer may be scraped in addition to the pure zinc layer and the pseudo alloy layer. In this case, performance of plating is deteriorated, and performance of the regeneration object WK will be deteriorated in the future. On the other hand, the boundary sample LM2 in the present embodiment shows a color of the surface of the regeneration object WK when a scraping work is performed to such a degree that the alloy layer is not influenced thereby. That is, according to the boundary sample LM2 in the present embodiment, a scraping work can be performed while the alloy layer is not influenced thereby.

As illustrated in FIG. 2, in step S34, the regeneration object WK is selected based on comparison between a state of a surface thereof and a photograph in the boundary sample LM2. Specifically, a scraping work to the regeneration object WK is terminated when the state of the surface thereof becomes identical or relatively close to a boundary sample indicating termination of the scraping work. When the state of the surface of the regeneration object WK has reached a boundary sample indicating termination of the scraping work among the boundary samples LM2 (step S30; YES), the scraping work is terminated. When the state of the surface of the regeneration object WK has not reached a boundary sample indicating termination of the scraping work (step S30; NO), the scraping work is continued.

A series of regeneration works to the regeneration object WK are terminated through coating (step S40) and drying (step S50) to manufacture the regenerated product RM.

As described above, in the method for manufacturing a regenerated product RM according to the present embodiment, a regeneration object WK is regenerated based on two evaluation standards (boundary samples LM1 and LM2). These evaluation standards indicate a state of a surface of the regeneration object WK, that is, a state of an appearance thereof. Therefore, the method for manufacturing a regenerated product RM according to the present embodiment can regenerate a regeneration object WK by visual check of an appearance of the regeneration object WK without use of an apparatus for measuring a plating thickness (for example, film thickness meter) or the like. Each of the two evaluation standards in the method for manufacturing a regenerated product RM according to the present embodiment is based on a boundary sample corresponding to the remaining plating thickness of a regeneration object WK. Therefore, the method for manufacturing a regenerated product RM according to the present embodiment can regenerate a regeneration object WK by maintaining the remaining plating thickness of the regeneration object WK to a predetermined thickness or more. This makes a use apparatus or a system of judgement simpler than a case of using an apparatus for measuring a plating thickness (for example, film thickness meter) or the like, and therefore the method for manufacturing a regenerated product RM according to the present embodiment can reduce labor and time for a work of manufacturing a regenerated product.

The method for manufacturing a regenerated product RM according to the present embodiment regenerates a regeneration object WK by stepwise applying the two evaluation standards (boundary samples LM1 and LM2). That is, the method for manufacturing a regenerated product RM according to the present embodiment regenerates a regeneration object WK by selection of the regeneration object WK in two stages. That is, the method for manufacturing a regenerated product RM according to the present embodiment can perform a rust-removing work by excluding a regeneration object WK not suitable for the rust-removing work among recovered regeneration objects WK. The method for manufacturing a regenerated product RM according to the present embodiment can thereby reduce labor and time for a rust-removing work compared to a case where selection is not performed stepwise.

The method for manufacturing a regenerated product RM according to the present embodiment sets the boundary sample LM2 such that the rust-removing work is terminated while rust generated in a regeneration object WK is not completely removed. The method for manufacturing a regenerated product RM according to the present embodiment can thereby suppress reduction in the remaining plating thickness to a value less than a predetermined threshold by the rust-removing work. Therefore, the method for manufacturing a regenerated product RM according to the present embodiment can improve the degree at which a function and performance of a regenerated product RM can be maintained in a predetermined durability period.

The method for manufacturing a regenerated product RM according to the present embodiment suppresses reduction in the remaining plating thickness to a value less than a predetermined threshold by using the boundary sample LM2. In general, when the remaining plating thickness becomes too small due to the rust-removing work, for example, when the remaining plating thickness becomes less than a predetermined threshold, the remaining plating thickness can be made to be a predetermined threshold or more by replating. However, replating needs a larger apparatus than rust-removing and coating, and therefore makes a procedure complicated. On the other hand, the method for manufacturing a regenerated product RM according to the present embodiment suppresses reduction in the remaining plating thickness to a value less than a predetermined threshold by using the boundary sample LM2, and therefore can manufacture a regenerated product RM without replating. That is, the method for manufacturing a regenerated product RM according to the present embodiment can manufacture the regenerated product RM even when the plant F for manufacturing a regenerated product does not include a plating apparatus such as a galvanizing tank. That is, the method for manufacturing a regenerated product RM according to the present embodiment can simplify an apparatus for manufacturing the regenerated product RM and reduce labor and time for a work.

The method for manufacturing a regenerated product RM according to the present embodiment can ship only a regenerated product RM which can maintain a function and performance in a predetermined durability period. Therefore, the method for manufacturing a regenerated product RM according to the present embodiment can largely reduce cost needed when a new product is purchased instead of the regenerated product RM.

Hereinabove, a case where the selection work (step S30) is performed in the rust-removing work (step S3) has been exemplified, but the present invention is not limited thereto. The selection work (step S30) may be performed in any step of the collection work (step S1) to the rust-removing work (step S3).

Hereinabove, a case where each work in the method for manufacturing a regenerated product RM is performed in the plant F for manufacturing a regenerated product has been exemplified, but the present invention is not limited thereto. Each work in the method for manufacturing a regenerated product RM may be performed at a site for recovering a regeneration object WK. For example, each work in the method for manufacturing a regenerated product RM may be performed at a site for rebuilding or relocating an electric pole. The method for manufacturing a regenerated product RM does not need an apparatus which is relatively difficult to be handled, such as a film thickness meter, or an apparatus which is relatively difficult to be conveyed, such as a galvanizing tank. That is, in this way, the method for manufacturing a regenerated product RM can reduce labor and time for a work even when the work is performed at a site.

Hereinabove, the embodiment of the present invention has been described in detail with reference to the drawings. However, a specific structure thereof is not limited to this embodiment, but can be modified appropriately within a range not departing from the gist of the present invention.

The apparatus, systems and methods in the above-described embodiments may be deployed in part or in whole through machines, a system of circuits, circuitry, hardware processors that executes computer software, software components, program codes, and/or instructions on one or more machines, a system of circuits, circuitry, hardware processors. In some cases, the one or more machines, a system of circuits, circuitry, hardware processors may be part of a general-purpose computer, a server, a cloud server, a client, network infrastructure, mobile computing platform, stationary computing platform, or other computing platform. One or more processors may be any kind of computational or processing device or devices which are capable of executing program instructions, codes, binary instructions and the like. The one or more hardware processors may be or include a signal processor, digital processor, embedded processor, microprocessor or any variants such as a co-processor, for example, math co-processor, graphic co-processor, communication co-processor and the like that may directly or indirectly facilitate execution of program codes or program instructions stored thereon. In addition, the one or more hardware processors may enable execution of multiple programs, threads, and codes. The threads may be executed simultaneously to enhance the performance of the one or more hardware processors and to facilitate simultaneous operations of the application. Program codes, program instructions and the like described herein may be implemented in one or more threads. The one or more hardware processors may include memory that stores codes, instructions and programs as described herein. The machines, a system of circuits, circuitry, hardware processors may access a non-transitory processor-readable storage medium through an interface that may store codes, instructions and programs as described herein and elsewhere. The non-transitory processor-readable storage medium associated with the machines, a system of circuits, circuitry, hardware processors for storing programs, codes, program instructions or other type of instructions capable of being executed by the computing or processing device may include but may not be limited to one or more of a memory, hard disk, flash drive, RAM, ROM, CD-ROM, DVD, cache and the like.

A processor may include one or more cores that may enhance speed and performance of a multiprocessor. In some embodiments, the process may be a dual core processor, quad core processors, other chip-level multiprocessor and the like that combine two or more independent cores.

The methods, apparatus and systems described herein may be deployed in part or in whole through a machine that executes computer software on a server, client, firewall, gateway, hub, router, or other such computer and/or networking hardware.

The software program may be associated with one or more client that may include a file client, print client, domain client, internet client, intranet client and other variants such as secondary client, host client, distributed client and the like. The client may include one or more of memories, processors, computer readable media, storage media, physical and virtual ports, communication devices, and interfaces capable of accessing other clients, servers, machines, and devices through a wired or a wireless medium, and the like. The programs or codes as described herein may be executed by the client. In addition, other devices required for execution of methods as described in this application may be considered as a part of the infrastructure associated with the client. The client may provide an interface to other devices including servers, other clients, printers, database servers, print servers, file servers, communication servers, distributed servers and the like. This coupling and/or connection may facilitate remote execution of program across the network. The networking of some or all of these devices may facilitate parallel processing of a program or method at one or more location. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The software program may be associated with one or more servers that may include a file server, print server, domain server, internet server, intranet server and other variants such as secondary server, host server, distributed server and the like. The server may include one or more of memories, processors, computer readable media, storage media, physical and virtual ports, communication devices, and interfaces capable of accessing other servers, clients, machines, and devices through a wired or a wireless medium, and the like. The methods, programs or codes as described herein may be executed by the server. In addition, other devices required for execution of methods as described in this application may be considered as a part of the infrastructure associated with the server. The server may provide an interface to other devices including clients, other servers, printers, database servers, print servers, file servers, communication servers, distributed servers, social networks, and the like. This coupling and/or connection may facilitate remote execution of program across the network. The networking of some or all of these devices may facilitate parallel processing of a program or method at one or more locations. Any of the devices attached to the server through an interface may include at least one storage medium capable of storing programs, codes and/or instructions. A central repository may provide program instructions to be executed on different devices. In this implementation, the remote repository may act as a storage medium for program codes, instructions, and programs.

The methods, apparatus and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing devices associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory, for example, USB sticks or keys, floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The modules, engines, components, and elements described herein, including in flow charts and block diagrams throughout the figures, imply logical boundaries between the modules, engines, components, and elements. However, according to software or hardware engineering practices, the modules, engines, components, and elements and the functions thereof may be implemented on one or more processors, computers, machines through computer executable media, which are capable of executing program instructions stored thereon as a monolithic software structure, as standalone software modules, or as modules that employ external routines, codes, services, or any combination of these, and all such implementations may be within the scope of the present disclosure. Examples of such machines may include, but is not limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers, processor-embedded eyewear and the like. Furthermore, the modules, engines, components, and elements in the flow chart and block diagrams or any other logical component may be implemented on one or more machines, computers or processors capable of executing program instructions. Whereas the foregoing descriptions and drawings to which the descriptions have been referred set forth some functional aspects of the disclosed systems, no particular arrangement of software for implementing these functional aspects should be inferred from these descriptions unless explicitly stated or otherwise clear from the context. It will also be appreciated that the various steps identified and described above may be varied, and that the order of steps may be adapted to particular applications of the techniques disclosed herein. All such variations and modifications are intended to fall within the scope of this disclosure. The descriptions of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

As used herein, the following directional terms “front, back, above, downward, right, left, vertical, horizontal, below, transverse, row and column” as well as any other similar directional terms refer to those instructions of a device equipped with embodiments of the present invention. Accordingly, these terms, as utilized to describe embodiments of the present invention should be interpreted relative to a device equipped with embodiments of the present invention.

Each element for the system, device and apparatus described above can be implemented by hardware with or without software. In some cases, the system, device and apparatus may be implemented by one or more hardware processors and one or more software components wherein the one or more software components are to be executed by the one or more hardware processors to implement each element for the system, device and apparatus. In some other cases, the system, device and apparatus may be implemented by a system of circuits or circuitry configured to perform each operation of each element for the system, device and apparatus.

While the present disclosure includes many embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. A method for manufacturing a regenerated product, comprising:
a selection step for selecting a recovered regeneration object based on a first evaluation standard indicating a state of a surface of the regeneration object with a discolored area;
a rust-removing step for performing a rust-removing treatment to the regeneration object selected by the selection step; and
a judgement step for judging whether to terminate the rust-removing treatment in the rust-removing step based on a second evaluation standard indicating the state of the surface of the regeneration object with the degree of discoloration.

2. The method for manufacturing a regenerated product according to claim 1, wherein the first evaluation standard is based on a boundary sample indicating a state of a surface of the recovered regeneration object according to a remaining plating thickness of the regeneration object.

3. The method for manufacturing a regenerated product according to claim 1, wherein the second evaluation standard is based on a boundary sample indicating a state of a surface of the regeneration object to which the rust-removing treatment has been performed in the rust-removing step according to a remaining plating thickness of the regeneration object.

4. The method for manufacturing a regenerated product according to claim 1, wherein each of the first evaluation standard and the second evaluation standard is based on a state of a color of a surface of the regeneration object.
